(19) United States
(12) Patent Application Publication
(10) Pub. No.: US 2009/0090677 A1
(43) Pub. Date: Apr. 9, 2009

(54) Method of treating organic compounds in groundwater

(75) Inventors: Hung-Ta Chen, Tainan City (TW); Shih-Lin Huang, Tainan City (TW); Yao-Hui Huang, Tainan City (TW); Juu-En Chang, Tainan City (TW); Min-Shing Tsai, Tainan City (TW)

Correspondence Address: Hung-Ta CHEN, P.O. BOX 90, Tainan City, 70499, TW

(73) Assignee: National Cheng Kung University

(21) Appl. No.: 11/907,008

(22) Filed: Oct. 9, 2007

(51) Int. Cl. C02F 1/72

(52) U.S. Cl. 210/747; 210/758

(57) ABSTRACT

A method of treating organic compounds in groundwater utilizes permeable catalytic barriers to carry out heterogeneous catalytic oxidation to degrade organic compounds. The permeable catalytic barriers are made of highly permeable catalytic materials, used to contact with the polluted groundwater mixed with oxidant to carry out heterogeneous catalytic oxidation to degrade organic compounds. Ditches are properly excavated to be filled with catalytic materials so as to form the permeable catalytic barriers. And, groundwater monitoring wells and oxidant injection wells are also built at proper locations, so that proper amount of oxidant can be determined and re-treatment can be promptly operated if necessary.

### BACKGROUND OF THE INVENTION

1. Field of the Invention

This invention relates to a method of treating organic compounds in groundwater, particularly to one able to treat BTEX (Benzene, Toluene, Ethylbenzene and Xylene) that leak out from Underground Storage Tanks (UST) to contaminate groundwater. The present invention is based on permeable catalytic barriers to carry out heterogeneous catalytic oxidation. The permeable catalytic barriers are made of highly permeable catalytic materials, used to contact with polluted groundwater mixed with oxidant to carry out heterogeneous catalytic oxidation to degrade organic compounds. The materials used for the permeable catalytic barriers can be commercial ones or made by a user himself, and are granulated or coated on carriers, with a particle size and a permeability coefficient larger than 0.5 mm and 10⁻² cm/sec respectively. The catalytic materials must be tested by TCLP and examination for micro amount of toxic compounds to assure they are friendly to the environment. It should be noted that the permeable catalytic barriers and oxidant injection wells are established at a point where groundwater flow through, so that proper amount of oxidant can be determined to achieve a high degradation of BTEX and re-treatment can promptly be done if necessary.

2. Description of the Prior Art

Commonly, BTEX are leaked out from Underground Storage Tanks (UST) and gas stations. As BTEX are lighter than water, having a low solubility to be classified as a Light Nonaqueous Phase Liquid (LNAPL), with a high Henry coefficient and a high vapor pressure, they are the contaminants spreading fast in underground. Basically, BTEX can be biologically decomposed, with a biological half-life lasting about several hours under aerobic condition and more than half a year under anaerobic condition. However, oxygen is always difficult to be widely spread to undertake aerobic decomposition for BTEX. For the time being, benzene and toluene are listed as controlled items of groundwater. Therefore, any factory location that has been tested to exceed the criteria for groundwater control must be listed as one to be monitored.

There are several techniques utilized to manage BTEX in the groundwater, including Pump and Treat, Air Stripping/Soil Vapor Extraction (AS/SVE), Thermal treatment such as stream stripping, In-Situ Chemical Oxidation (ISCO) such as a reaction of Fenton or Fenton-like, Bioremediation such as Bioventing, Bioslurping and Oxygen Release Compounds, Permeable Reactive Barriers (PRBs), and Natural Attenuation (N/A). Among them, although Air Stripping/Soil Vapor Extraction (AS/SVE) is disclosed as the best available control technology by US Environmental Protection Agency, but it needs extra power to carry on and has to further manage the contaminants physically isolated while processing. In addition, phase transfer of the contaminants may occur to create other contamination that must be subsequently treated if AS/SVE is not properly executed.

In-Situ Chemical Oxidation (ISCO), also called Advanced Oxidation Process (AOP), has been used in the past, processed by using oxidants, such as hydrogen peroxide, ozone, potassium permanganate and sodium persulfate, or catalysts to react with organic compounds in groundwater for decomposition. And, granted in US, there is also a patent (U.S. Pat. No. 7,175,770) based on oxidants of H₂O₂/O₃ to renovate soil and groundwater. Of course, it should be attentively noticed that whether the oxidants are to directly contact with contaminants, whether any other intermediate product is formed after oxidation, and to realize the toxicity of the intermediate products if found.

Iron oxides are classified as the crystalline and the amorphous. The crystalline iron oxides include α-Fe₂O₃, α-FeOOH and Γ-FeOOH and Fe₃O₄. Ferrihydrite is an amorphous iron oxide. Iron oxides have been widely applied in treating wastewater, purifying polluted air, and renovating underground pollution. In wastewater treatment, iron oxide coating has been employed to absorb and catalytically oxidize organic and inorganic compounds. Fluidized beds have also been used to treat wastewater with organic and inorganic compounds that are difficult to be decomposed biologically. In addition, iron oxides have been utilized to get rid of hydrogen sulfide in polluted emission, and to catalytically oxidize organic compounds contained in underground. Or, zero-valent iron is used to carry out dehalogenation of halogenated organic compounds.

Basically, the formulas for reactions of hydrogen peroxide catalyzed on the surface of iron oxides are as follows,

H₂O₂→HO₂⁻+H⁺

mM+H₂O₂→mM⁺+OH⁻+•OH

mM⁺+HO₂⁻→MM⁺⁻+•OH₂

H₂O₂+•OH→H₂O+•OH₂

•OH₂→H⁺+•O₂⁻

mM⁺+•O₂⁻→mM+O₂

mM+•HO₂→mM⁺+HO₂⁻

H₂O₂+•O₂⁻→•OH+OH⁻+O₂

H₂O₂+•HO₂→•OH+H₂O+O₂

A catalytic reaction of Fenton-like composed of iron oxides, such as goethite and ferrite, and oxidants have also been applied to renovate polluted soil and groundwater. The mechanism for iron oxides to diminish contaminants includes catalytic oxidation and adsorption. The catalytic oxidation is based on a dominant catalysis of iron oxides to hydrogen peroxide so as to renovate soil and groundwater, or relies on photo catalysis to degrade organic compounds, such as BTEX, phenol, nitrophenols and chlorophenol. As iron oxides have a great amount of adsorption sites and a high specific area, they are excellent absorber, having been utilized to treat inorganic anions, such as nitrates and phosphates, organic anions or molecules such as humic acid and fulvic acid, and metallic ions such as aluminum, plumbum, copper and nickel ions. But, it is always restricted by the expense of oxidants and pH condition, so that Fenton-like reaction may decompose organic compounds. In addition, the particle sizes of iron oxides are too tiny to often cause clogging, which must be solved by coating granules and mixed granulation to enhance water permeability and carrying capability.

The present invention is based on the theory of Fenton-like process combined with technique of Permeable Reactive Barrier (PRB) to deal with soil and groundwater contaminated by organic compounds, having no adsorption problem of contaminants as it takes advantage of catalysis of granules employed, so that the granules do not have to be taken out or replaced with fresh ones. In the past, the Permeable Reactive Barrier (PRB) used to renovate in-situ polluted groundwater is mainly processed with active carbon or via mixing oxygen release compounds with in-situ soil or sand to carry out adsorption or biodegradation. The Permeable Reactive Barrier (PRB) can basically treat heavy metal ions and organic contaminants by means of adsorption, precipitation and degradation of the reagents contained therein. The reacting agents usually seen include active carbon, oxygen release compounds, zero-valent iron and nano iron. However, as the reagents have a certain capacity, they have to be dug out or further treated while being saturated or inactive. Permeable Catalytic Barriers (PCBs) is a brand-new technique different from the conventional Permeable Reactive Barriers (PRBs), utilizing carriers to be coated with iron oxide or granulated and then, added with oxidants to execute catalytic oxidation to diminish organic contaminants in groundwater. Permeable Catalytic Barriers (PCBs) is used to treat organic compounds, utilizing oxidants, such as hydrogen peroxide, as reagents to carry out heterogeneous catalytic oxidation. As iron oxide-coated barriers are acting as a catalyst, they are not consumables. And, the organic compounds are to be mineralized after being catalytically oxidized, unnecessary to be treated further. The comparisons between PRBs and PCBs are shown in Table 1.

TABLE 1
Technical comparisons between Permeable Reactive Barriers
(PRBs) and Permeable Catalytic Barriers (PCBs)

| Items | PRBs | PCBs |
|---|---|---|
| Targets to be treated | Heavy metals, organic | Organic compounds |
| | compounds | |
| Theories (main | Adsorption/absorption, | Catalytic oxidation |
| reaction mechanism) | chemical precipitation, | |
| | oxidation/reduction | |
| Reacting materials | Reacting agents of | Oxidants extra added |
| | barriers | |
| Usage of barriers | Reaction | Catalysis |
| Reagents used | Zero-valent iron, active | Oxidants (such as |
| | carbon, oxygen release | hydrogen peroxide and |
| | compounds | peroxides) |
| Consumption of | As iron is a reacting agent, | As iron oxide is a |
| barriers | it must be taken out after | catalyst, only for |
| | being used up. | catalysis, it is not to be |
| | | consumed. |
| Decomposition of | Contaminants adsorbed or | As it is a catalytic |
| contaminants | absorbed have to be | oxidation, no further |
| | treated further. | treatment is necessary. |

For the time being, BTEX is mainly processed by AS/SVE, which has to not only be proceeded with a long-term power, but also further treat gaseous contaminants collected therein. Moreover, AS/SVE must be combined with a subsequent treatment, such as a catalytic oxidation of ozone or titanium dioxide. In the present invention, via taking advantage of hydraulic dynamics of groundwater itself, groundwater contaminated with BTEX is previously mixed with oxidants and then, guided to Permeable Catalytic Barriers (PCBs) to carry out heterogeneous catalytic oxidation to keep BTEX quickly degraded. Compared with In-situ chemical oxidation process, the present invention based on heterogeneous catalytic oxidation of Permeable Catalytic Barriers (PCBs) has a lower consumption of oxidants, and can carry out re-treatment if the concentration of BTEX rebounds. In other words, the present invention is provided with oxidant injection wells, Permeable Catalytic Barriers and groundwater monitoring wells for integrally treating pollutants and monitoring groundwater.

### SUMMARY OF THE INVENTION

The objective of this invention is to offer a method of treating organic compounds in groundwater.

The present invention is provided with permeable catalytic barriers to carry out heterogeneous catalytic oxidation to degrade BTEX in groundwater. Oxidant is previously blended with groundwater polluted with BTEX to obtain a pH value ranging from 2 to 7 and a temperature of 30° C. Hydrogen peroxide (30%˜50%, actually diluted below 3% for safety concern) is used as the oxidant, mixed with BTEX by BTEX/H₂O₂= 1/32˜1/96 (by wt). BTEX can be sharply degraded as the groundwater mixture flows through the permeable catalytic barriers. Besides the permeable catalytic barriers, the present invention is also provided with groundwater monitoring wells and oxidant injection wells to integrally monitor and treat groundwater.

The targets of the present invention are described below.

1. Different from PRBs, Permeable catalytic barriers (PCBs) is mainly based on catalytic oxidation, with oxidant extra added to keep organic compounds catalytically oxidized by iron oxide.

2. With catalytic materials coated on carriers or granulated, the particle size of PCBs can be enlarged to increase permeability.

3. As the present invention has lower consumption of oxidant and higher degradation than ISCO does, it is of course operated more economically than ISCO is.

4. The oxidant injection wells are located in front of the permeable catalytic barriers, used to make oxidant jetted into and mixed with groundwater in advance. And, with the permeable catalytic barriers disposed at the down stream of groundwater, the groundwater mixed with oxidant is to flow through the permeable catalytic barriers under natural hydraulic dynamics. Therefore, the devices of the present invention are quite simple.

### BRIEF DESCRIPTION OF DRAWINGS

This invention is better understood by referring to the accompanying drawings, wherein:

FIG. 1 is an illustration for the location of devices in a preferred embodiment of a method of treating organic compounds in groundwater in the present invention;

FIG. 2 is a flow chart of procedures for the preferred embodiment of a method of treating organic compounds in groundwater in the present invention;

FIG. 3 shows a relation between the flow rate of groundwater and degradation of BTEX in the preferred embodiment of a method of treating organic compounds in groundwater in the present invention;

FIG. 4 shows a relation between thickness of permeable catalytic barriers and degradation of BTEX in the preferred embodiment of a method of treating organic compounds in groundwater in the present invention; and

FIG. 5 shows a relation between amount of oxidant added and degradation of BTEX in the preferred embodiment of a method of treating organic compounds in groundwater in the present invention.

### DETAILED DESCRIPTION OF THE PREFERRED EMBODIMENT

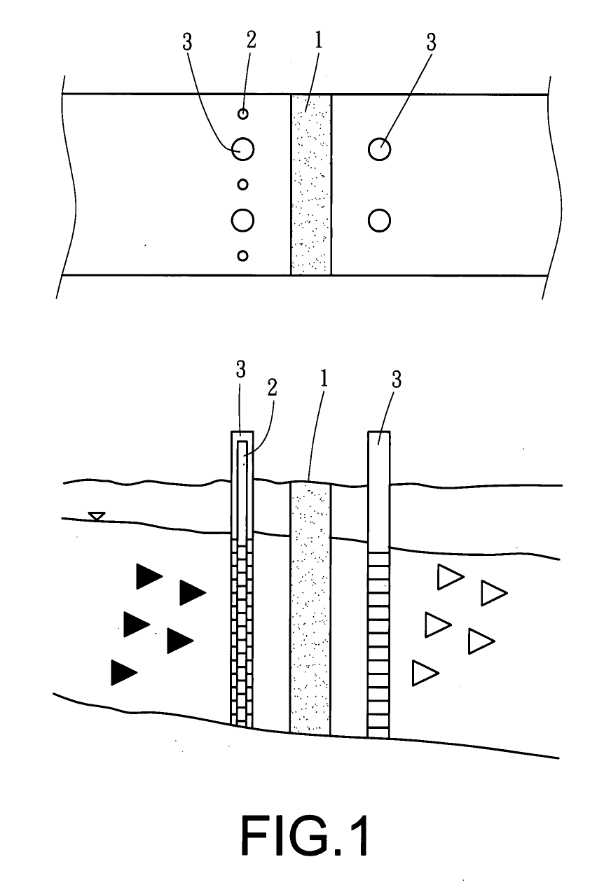

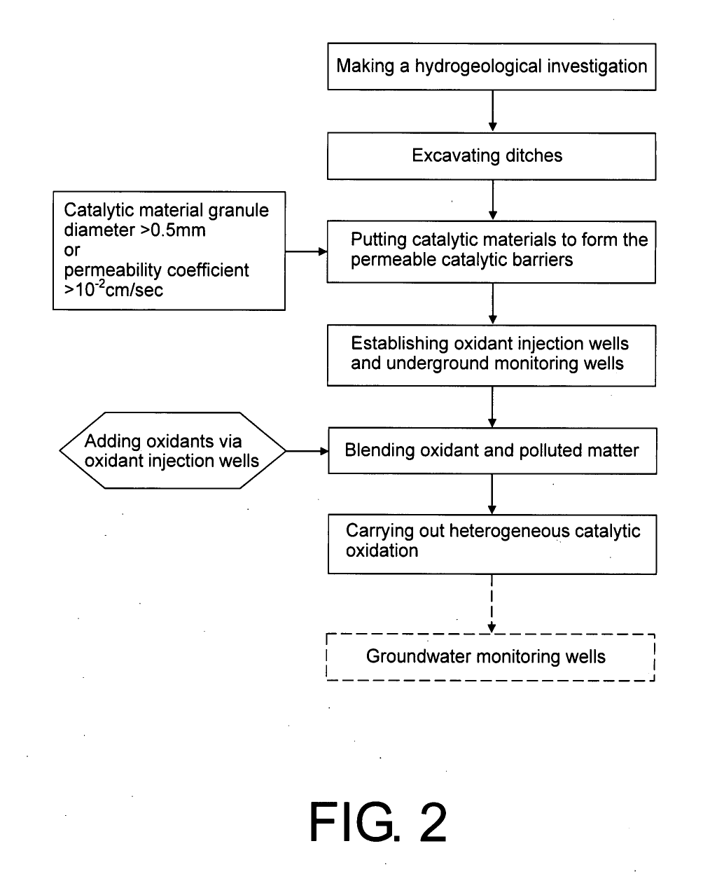

As shown in FIGS. 1 and 2, a preferred embodiment of a method of treating organic compounds in groundwater in the present invention has procedures as described below.

1. Prepare catalytic materials with good ability of catalysis, good permeability, good environmental friendly and characteristics as mentioned below.

(a) Catalysis: Directly mix quartz or other substrates with catalytic materials, such as iron oxide and titanium dioxide, to proceed with granulation, keeping granules coated with the catalytic materials.

(b) Permeability: Assure the granules used for permeable catalytic barriers having a diameter larger than 0.5 mm or a permeability coefficient bigger than 10⁻² cm/sec.

(c) Environmental friendly: Make permeable catalytic barriers tested with TCLP to confirm if they are toxic and contain harmful organic compounds.

2. Make a hydrogeological investigation to realize the distribution of contaminants and then, make a design of permeable catalytic barriers 1.

3. Excavate ditches by means of proper equipment.

4. Put the catalytic materials prepared previously in the ditches to form the permeable catalytic barriers 1.

5. Establish oxidant injection wells 2 and groundwater monitoring wells 3 as described below.

(a) The groundwater monitoring wells 3 are employed to realize the quality of groundwater, so as to determine the amount of oxidant to be added.

(b) The oxidant injection wells 2 are the devices prepared for being added with oxidant.

6. Via oxidant injection wells 2, inject oxidants, such as hydrogen peroxide and peroxides, to pre-mix with groundwater contaminated.

7. Guide the pre-mixed groundwater to flow through the groundwater monitoring wells 3 to carry out heterogeneous catalytic oxidation, and make sure that the catalytic materials of the permeable catalytic barriers 1 can reach a 95% capability of catalytic oxidation to organic compounds.

Thus, established with the permeable catalytic barriers 1, the present invention can keep BTEX in groundwater quickly degraded and re-treat them if their concentration rebounds. Basically, heterogeneous catalysis is the main mechanism utilized to treat BTEX in permeable catalytic barriers, thus the reacting agents are oxidants. But, as the present invention is based on heterogeneous catalytic oxidation, oxidant used can be largely lessened. Moreover, BTEX can flow through the permeable catalytic barriers 1 continuously to be treated owing to a rather large size of the granules of the permeable catalytic barriers 1. So, with the advantage of groundwater hydraulic dynamics and less consumption of oxidant, the present invention is really an economic method to treat BTEX in groundwater.

The following is an example, which has been experimented to express the effect achieved.

### EXAMPLE 1

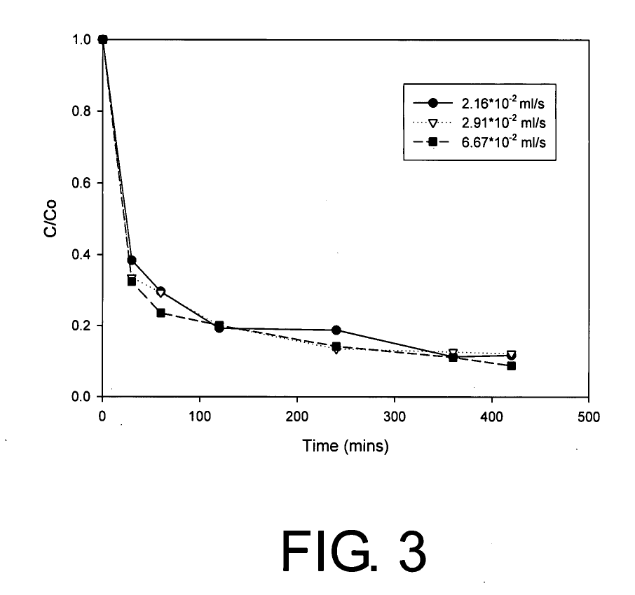

FIG. 3 shows the relation between flow rate and degradation. First, prepare the catalytic material and then, place it in the permeable catalytic barrier 1. Next, prepare one liter of 22 ppm benzene solution and then, blend it with one liter of 704 ppm hydrogen peroxide. The mixed polluted water is forced to flow through the permeable catalytic barrier 1, which has a thickness of 40 cm, a permeability (k) of 0.297 cm/sec, a porosity (ρ) of 0.4, and a flow rate controlled as 2.16, 2.91 and 6.67*10⁻² cm³/s respectively. Analyzed by Gas Chromatography, it is found that 91.2% of benzene has been degraded and flow rate has little effect to degradation.

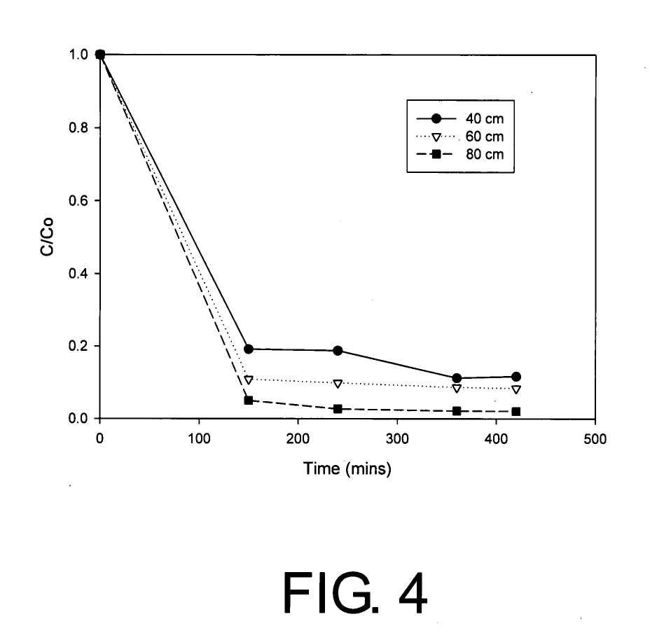

FIG. 4 shows the relation between thickness of the permeable catalytic barrier 1 and degradation. First, prepare the catalytic material and then, place it in the permeable catalytic barrier 1. Next, prepare one liter of 22 ppm benzene solution and then, blend it with one liter of 704 ppm hydrogen peroxide. The mixed polluted water is forced to flow through the permeable catalytic barrier 1, which has a thickness of 40, 60 and 80 cm respectively, a permeability (k) of 0.297 cm/sec, a porosity (ρ) of 0.4, and a flow rate of 6.67*10⁻² cm³/s. Analyzed by Gas Chromatography, it is found that 98.2% of benzene has been degraded and the degradation rises as the thickness is increased.

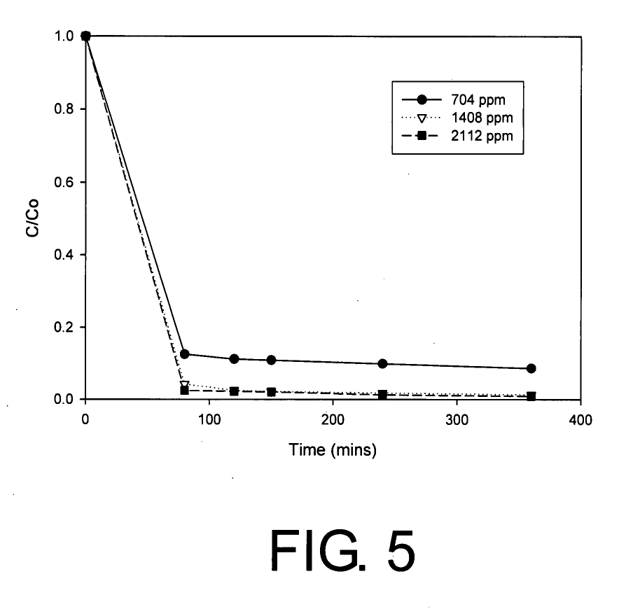

FIG. 5 shows the relation between concentration of hydrogen peroxide and degradation. First, prepare the catalytic material and then, place it in the permeable catalytic barrier 1. Next, prepare one liter of 22 ppm benzene solution and then, blend it with one liter of 704 ppm, 1408 ppm and 2112 ppm hydrogen peroxide respectively. The diverse mixed polluted waters are respectively forced to flow through the permeable catalytic barrier 1, which has a thickness of 60 cm, a permeability (k) of 0.297 cm/sec, a porosity (ρ) of 0.4, and a flow rate of 6.67*10⁻² cm³/s. Analyzed by Gas Chromatography, it is found that 99.36% of benzene has been degraded and the degradation rises as the concentration of the hydrogen peroxide is increased.

The invention has the following advantages as can be seen from the foresaid description.

1. The present invention can be processed in-situ, thus there is no problem of wastewater disposal. And, as catalyst is used to carry out catalysis, reacting agents are not necessary to be taken out for regeneration or replaced with new ones.

2. Via hydrogeological investigation in situ, the present invention can take advantage of groundwater hydraulic dynamics to guide the groundwater to flow toward the permeable catalytic barriers 1 so as to save a great deal of power expense. So, the present invention can be constructed more economically than the conventional processes can.

3. With catalytic oxidation reaction, the present invention not only consumes much less oxidant than In-situ chemical oxidation process does, but also obtains higher degradation of BTEX contaminants.

4. The catalytic materials used for permeable catalytic barrier 1 are friendly to the environment, without any toxicity leaching.

5. Monitored by the groundwater monitoring wells 3, the necessary amount of oxidant to be injected in can be determined properly, and BTEX can be promptly re-treated if their concentration rebounds. Thus, the present invention can monitor and treat groundwater with BTEX chronically.

While the preferred embodiment of the invention has been described above, it will be recognized and understood that various modifications may be made therein and the appended claims are intended to cover all such modifications that may fall within the spirit and scope of the invention.

What is claimed is:

1. A method of treating organic compounds in groundwater comprising:
(1) hydrogeological investigation: realizing a distribution of contaminants so as to design permeable catalytic barriers;
(2) excavating ditches: excavating ditches at proper locations in accordance to the distribution of the contaminants known from said step (1);
(3) building said permeable catalytic barriers putting catalytic materials into said ditches to form said permeable catalytic barriers; and
(4) establishing wells: disposing oxidant injection wells at an upper stream of said permeable catalytic barriers to let oxidant injected in to previously mix with polluted groundwater, so as consecutively carry out heterogeneous catalytic oxidation to degrade organic compounds in groundwater; and
wherein a granule diameter of said catalytic materials of said permeable catalytic barriers is larger than 0.5 mm;
wherein said catalytic materials of said permeable catalytic barriers has a permeability coefficient bigger than 10⁻² cm/sec; and
wherein said catalytic materials are previously shaped as blocks that are piled up to form said permeable catalytic barrier.

2 to 4. (canceled)

5. The method of treating organic compounds in groundwater as claimed in claim 1, wherein groundwater monitoring wells are established in front of said permeable catalytic barriers.

6. The method of treating organic compounds in groundwater as claimed in claim 1, wherein said groundwater monitoring wells are established behind said permeable catalytic barriers.

7. The method of treating organic compounds in groundwater as claimed in claim 1, wherein said groundwater monitoring wells are established in front of and behind said permeable catalytic barriers.

8. The method of treating organic compounds in groundwater as claimed in claim 1, wherein a mixing weight ratio of organic/oxidant is ranging from 1:10 to 1:200 for organic compounds in groundwater and said oxidant.

9. The method of treating organic compounds in groundwater as claimed in claim 1, wherein said permeable catalytic barriers are formed by directly filling said catalytic material in said ditches.

10. The method of treating organic compounds in groundwater as claimed in claim 1, wherein said permeable catalytic barriers are formed by filling a mixture of said catalytic material and other materials into said ditches.

11 to 12. (canceled)

13. The method of treating organic compounds in groundwater as claimed in claim 1, wherein said permeable catalytic barriers are made of a permeable cloth containing catalytic materials.
